(19) United States
(12) Patent Application Publication
(10) Pub. No.: US 2011/0101909 A1
(43) Pub. Date: May 5, 2011

(54) SYSTEMS INVOLVING GENERATION OF ELECTRICAL POWER

(75) Inventor: Timothy Bowman, Cartersville, GA (US)

(73) Assignee: NEW CREATIVE CONCEPTS, Cartersville, GA (US)

(21) Appl. No.: 12/756,304

(22) Filed: Apr. 8, 2010

Related U.S. Application Data
(60) Provisional application No. 61/257,169, filed on Nov. 2, 2009.

(51) Int. Cl. H02J 7/00

(52) U.S. Cl. 320/103

(57) ABSTRACT

Systems involving generation of electrical power are provided. In this regard, a representative system includes: two rechargeable batteries; a DC-to-AC inverter; and a self-recharging system operative to alternately recharge a first of the batteries using charge provided from a second of the batteries, and recharge the second of the batteries using charge provided from the first of the batteries; wherein the DC-to-AC inverter is operative to direct charge from the first of the batteries to a load during recharge of the second of the batteries, and to direct charge from the second of the batteries to the load during recharge of the first of the batteries.

### CROSS-REFERENCE TO RELATED APPLICATION

This utility application claims the benefit of and priority to U.S. Provisional Patent Application 61/257,169, which was filed on Nov. 2, 2009, and which is incorporated by reference herein in its entirety.

### BACKGROUND

1. Technical Field

The disclosure relates to portable power supplies.

2. Description of the Related Art

Numerous devices are available that use rechargeable batteries. However, the power demands of many of these devices are oftentimes so great that users keep multiple batteries on-hand. As one battery is depleted by use, it is removed from the device and set for recharging, while another battery is put in the device. Depending on what the device is, this switching of batteries can be very disruptive.

### SUMMARY

Systems involving generation of electrical power are provided. In this regard, an exemplary embodiment of a system comprises: two rechargeable batteries; a DC-to-AC inverter; and a self-recharging system operative to alternately recharge a first of the batteries using charge provided from a second of the batteries, and recharge the second of the batteries using charge provided from the first of the batteries; wherein the DC-to-AC inverter is operative to direct charge from the first of the batteries to a load during recharge of the second of the batteries, and to direct charge from the second of the batteries to the load during recharge of the first of the batteries.

Another exemplary embodiment of a system is configured as a cordless power tool and comprises: two rechargeable batteries; and a motor; wherein the tool is operative to recharge itself to the extent that a battery can be recharged using kinetic energy from rotation of the motor to generate energy needed to recharge the batteries.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure.

### BRIEF DESCRIPTION OF THE DRAWINGS

Many aspects of the disclosure can be better understood with reference to the following drawings. The components in the drawings are not necessarily to scale.

FIG. 1 is a schematic diagram depicting an exemplary embodiment of a system.

FIG. 2 is a schematic diagram depicting another exemplary embodiment of a system that incorporates a generator.

FIG. 3 is a schematic diagram depicting an exemplary embodiment of a system that incorporates photovoltaic cells.

FIG. 4 is a schematic diagram depicting another exemplary embodiment of a system that incorporates photovoltaic cells.

FIG. 5 is a schematic diagram depicting an exemplary embodiment of a system implemented within a powered device.

FIG. 6 is a schematic diagram depicting another exemplary embodiment of a system.

FIG. 7 is a schematic diagram depicting another exemplary embodiment of a system that incorporates a backpack-type carrying pack.

FIG. 8 is a schematic diagram depicting another exemplary embodiment of a system that incorporates a hip pack-type carrying pack.

### DETAILED DESCRIPTION

Systems involving generation of electrical power are provided, several exemplary embodiments of which will be described in detail. In some embodiments, such a system can be configured as a portable power supply that can easily be transported by a person who may need household A/C power in remote or distant locations where a power supply may not be available. For example, the system could be implemented with a backpack for transporting various components of the system. The power supply can be self-recharging, such as to the capabilities that a battery can be recharged. Notably, a potential problem exists in that it oftentimes takes 145 amp hours to recharge a 100 amp battery supply. In order to better ensure an uninterrupted power supply for longer periods of time, some embodiments convert additional power from another source to make up for the amp hour lapse.

In some embodiments, the system includes two or more batteries that alternately supply power to the load while the other battery is being recharged. A smart switch can be used to divert the power supply from one battery to another and can also switch a source of charging power to recharge the depleted battery (e.g., both switching operations may occur simultaneously).

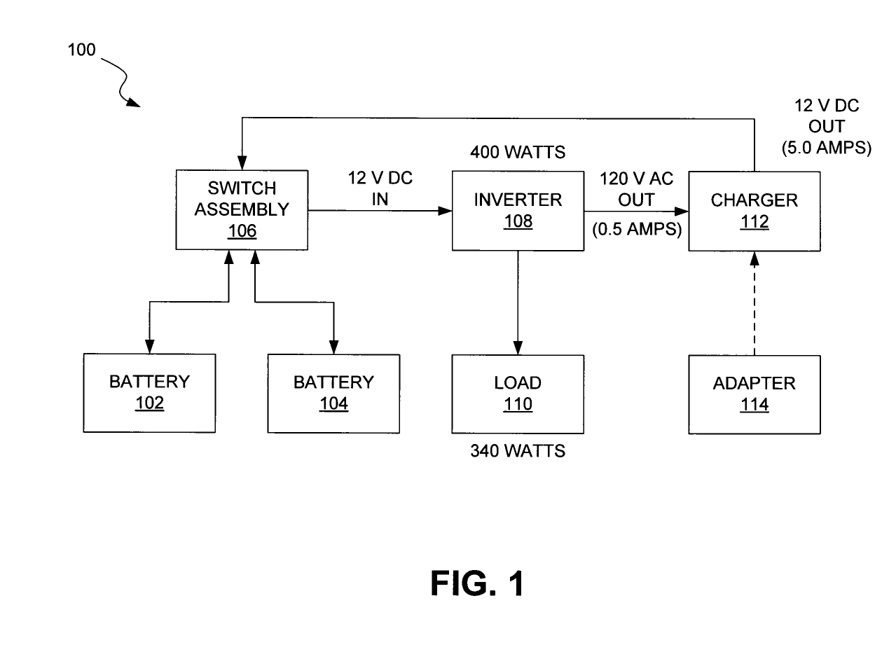

FIG. 1 is a schematic diagram depicting an exemplary embodiment of a system. As shown in FIG. 1, system 100 includes rechargeable batteries 102, 104 (e.g., lithium ion, Ni-cD, Ni-mH, among others), which are electrically connected to switch assembly 106. Switch assembly 106 is electrically connected to an inverter 108, which receives DC power from the switch assembly. The inverter is electrically connected to a load 110 and also to a charger 112, which is configured as a step down transformer in this embodiment. Charger 112 is electrically connected to switch assembly 106.

In operation, the switch assembly directs the flow of electrical power from a selected one of the batteries 102, 104, while permitting charging of the other. Power from the selected battery (e.g., 12 V DC) is provided via the switch assembly to the inverter, which is configured in this embodiment for outputting 400 Watts. The inverter directs a portion of its output to the load while directing the remaining portion to the charger. In this embodiment, 340 Watts is provided to load, while 60 Watts (in the form of 120 V AC at 0.5 amps) is provided to the charger.

The windings (e.g., 10 to 1 windings) of the step down transformer of the charger converts the received output of the inverter to a DC output for recharging (e.g., trickle charging) the battery that is not currently providing power for use by the inverter. In this embodiment, the charger provides an output of 12 V DC (60 watts) to charge the second battery via the switch assembly. This provides 340 watts power to use for the load needed. As such, the batteries, switch assembly, inverter and charger of this embodiment constitute a self-recharging system. Since energy is converted using electromagnetic induction, this system does not constitute a perpetual power supply, as the original battery components will deteriorate over time and will eventually not be self rechargeable.

The embodiment of FIG. 1 (as may other embodiments) may also include an optional adapter 114, which can be configure to receive electrical power from on or more of various sources. By way of example, the adapter can be configured for plugging in to a standard car receptacle. In this manner, alternate or additional electrical power can be providing for charging one or more of the batteries.

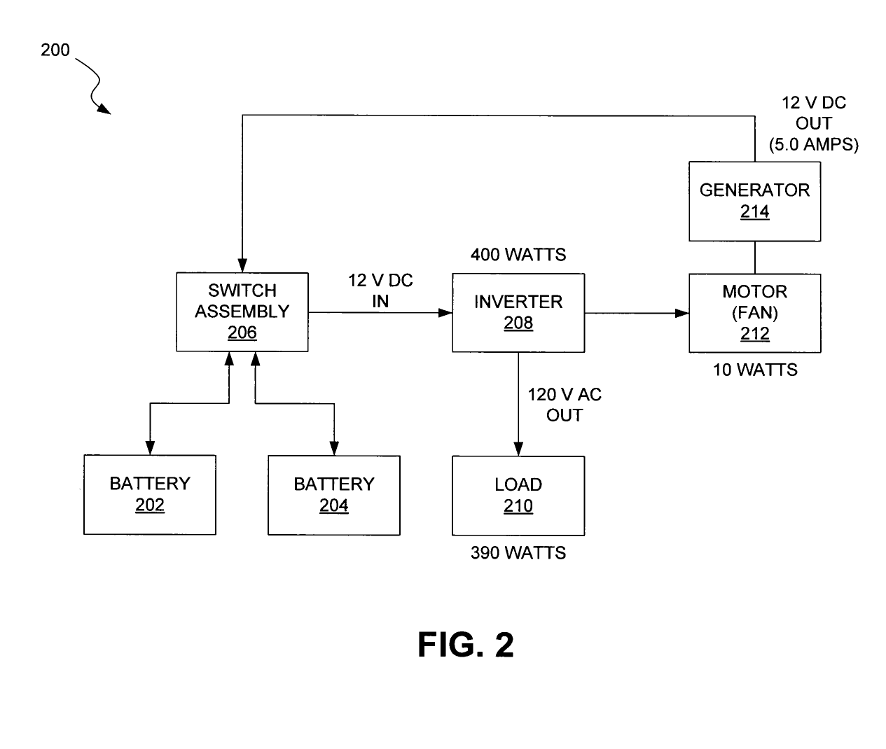

FIG. 2 is a schematic diagram depicting another exemplary embodiment of a system. As shown in FIG. 2, system 200 includes rechargeable batteries 202, 204, which are electrically connected to switch assembly 206. Switch assembly 206 is electrically connected to an inverter 208, which receives DC power from the switch assembly. The inverter is electrically connected to a load 210 and a motor 212. Motor 212 (which can be a cooling fan motor that keeps the inverter cool, for example) turns generator 214 for generating electrical power.

In operation, the switch assembly directs the flow of electrical power from a selected one of the batteries 202, 204, while permitting charging of the other. Power from the selected battery (e.g., 12 V DC) is provided via the switch assembly to the inverter, which is configured in this embodiment for outputting 400 Watts. The inverter directs a portion of its output to the load while directing the remaining portion to the motor. In this embodiment, 390 Watts is provided to load, while 10 Watts is provided to the motor. As such, power associated with the rotation of the motor is used to generate DC power with the generator (e.g., a brushless dc generator). The generator in this embodiment may be able to produce 12 volts DC and 5 amps (60 Watts). The generator would charge the second battery via the switch assembly while the other battery is supplying the inverter.

It should be noted that switch assembly 206 can include one or more switches for performing the functions described above. Such switches can be controlled in various manners as should be understood by one of ordinary skill.

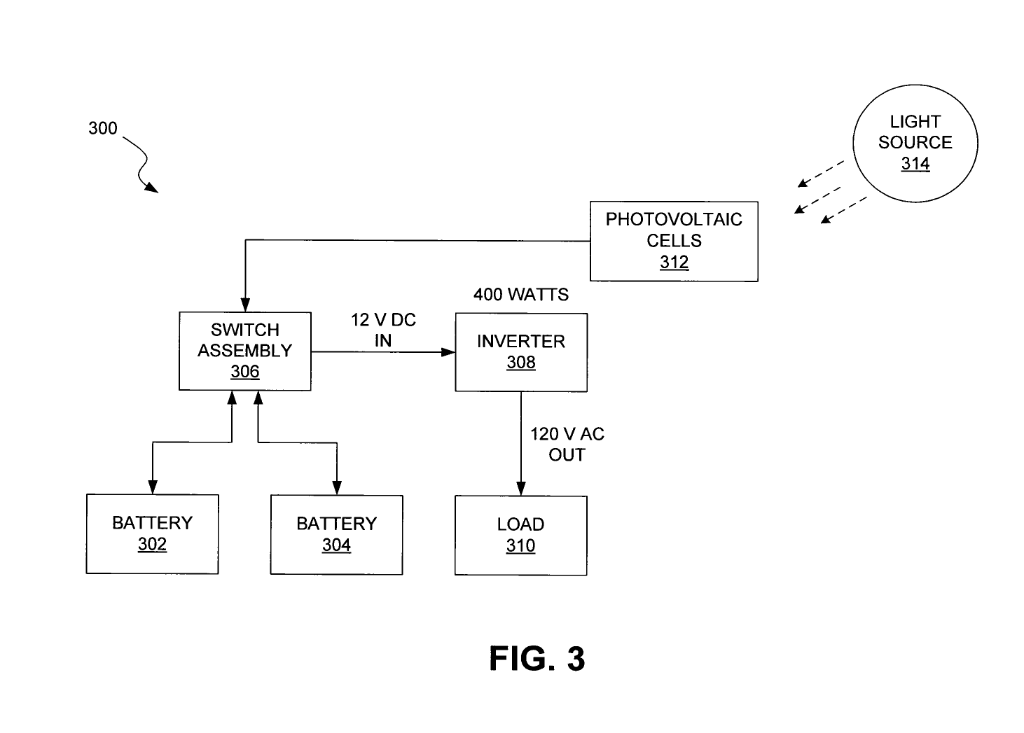

FIG. 3 is a schematic diagram depicting another exemplary embodiment of a system. As shown in FIG. 3, system 300 includes rechargeable batteries 302, 304, which are electrically connected to switch assembly 306. Switch assembly 306 is electrically connected to an inverter 308, which receives DC power from the switch assembly. The inverter is electrically connected to a load 310. Additionally, one or more photovoltaic cells 312 are provided, the electrical output of which is connected to the switch assembly for recharging the batteries.

In operation, the switch assembly directs the flow of electrical power from a selected one of the batteries 302, 304, while permitting charging of the other. Power from the selected battery (e.g., 12 V DC) is provided via the switch assembly to the inverter, which is configured in this embodiment for outputting 400 Watts. The inverter directs its output to the load.

By using photovoltaic cells, power from a light source 314 (e.g., the sun) is captured, converted and used to recharge the second battery. Although the power derived from current photovoltaic cells is relatively small, the material used to make them may be altered to generate as much as 1000 watts per square meter which would be sufficient to recharge a battery.

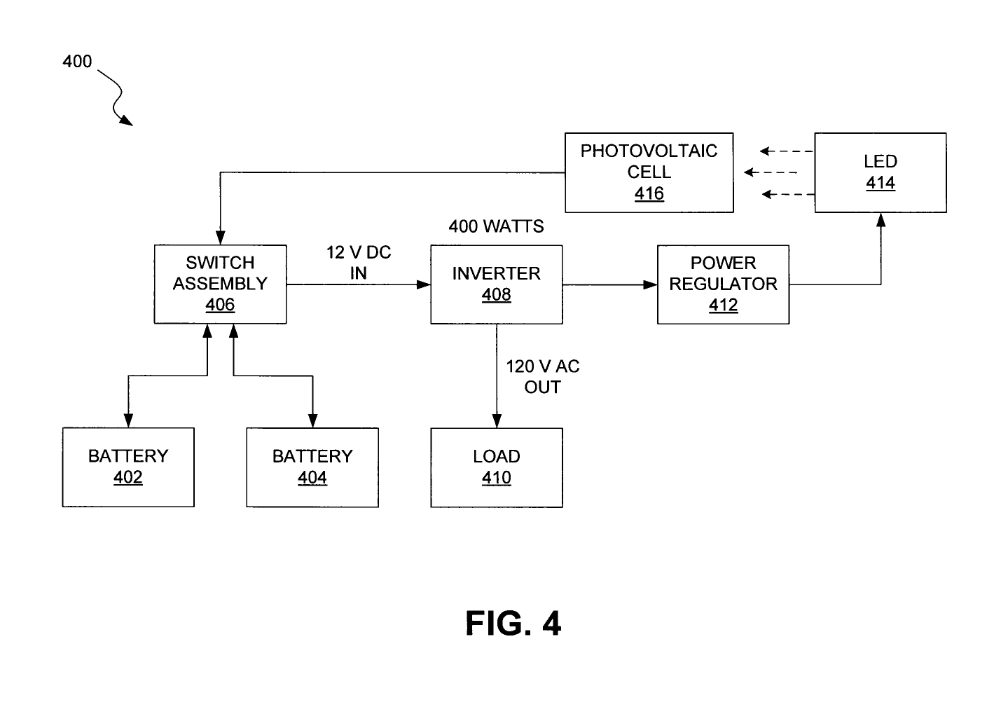

FIG. 4 is a schematic diagram depicting another exemplary embodiment of a system. As shown in FIG. 4, system 400 includes rechargeable batteries 402, 404, which are electrically connected to switch assembly 406. Switch assembly 406 is electrically connected to an inverter 408, which receives DC power from the switch assembly. The inverter is electrically connected to a load 410 and to a power regulator 412. The power regulator is electrically connected to LED's 414. Additionally, one or more photovoltaic cells 416 are oriented for receiving light from the LED's and are electrically connected to the switch assembly.

In operation, the switch assembly directs the flow of electrical power from a selected one of the batteries 402, 404, while permitting charging of the other. Power from the selected battery (e.g., 12 V DC) is provided via the switch assembly to the inverter, which is configured in this embodiment for outputting 400 Watts. The inverter directs a portion of its output to the load while directing the remaining portion to a power regulator, which provides an appropriate output (e.g., 3 V DC) to the LED's. The photovoltaic cells convert the light from the LED's to electrical power that is provided to the switch assembly for recharging the batteries.

Various configurations of LED's can be used, including those which incorporate LED's of different colors (e.g., red, green and blue LED's).

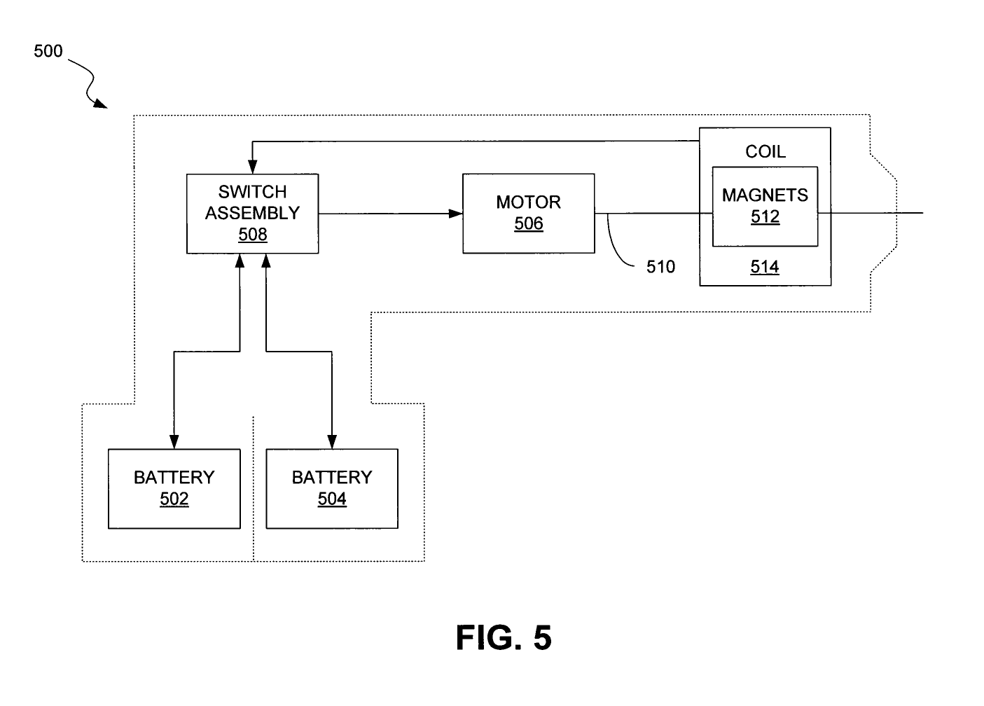

FIG. 5 is a schematic diagram depicting another exemplary embodiment of a system. In this embodiment, system 500 is configured as a cordless power tool (e.g., a cordless drill). Rechargeable batteries 502 and 504 are provided that alternately power motor 506 via a switch assembly 508. A rotatable shaft 510 extends from the motor with magnets 512 being mounted to rotate with the shaft. A coil 514 is positioned about the magnets and is electrically connected to the switch assembly.

In operation, the switch assembly directs the flow of electrical power from a selected one of the batteries 502, 504, while permitting charging of the other. The flow of electrical power rotates the motor, the kinetic energy of which is used to generate electrical power via the magnets and coil for recharging the batteries. Notably, in this embodiment, a split-battery configuration is used (i.e., each battery is separate and can be separately replaced). In other embodiments, the batteries can be provided as an integrated set that is replaced together.

Notably, various embodiments of systems (such as the exemplary embodiments described above) may be put into a portable power pack supply form to include fanny packs, back packs, or other hand held means to transport the operating system. This will allow people to use common household energy in remote locations or when power outages occur.

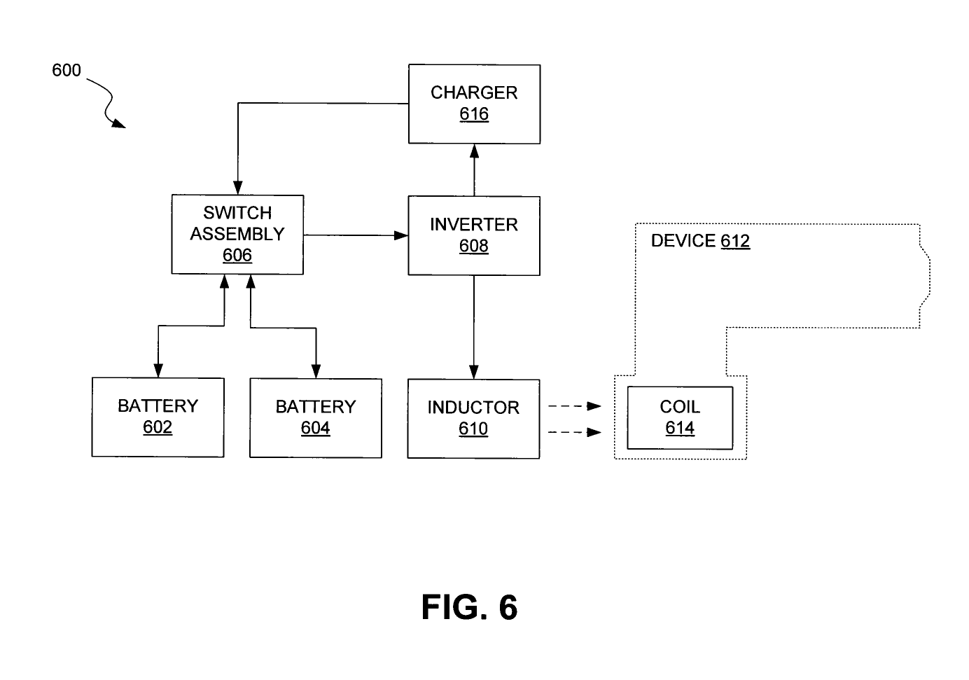

FIG. 6 is a schematic diagram depicting another exemplary embodiment of a system. As shown in FIG. 6, system 600 includes rechargeable batteries 602, 604, which are electrically connected to switch assembly 606. Switch assembly 606 is electrically connected to an inverter 608, which receives DC power from the switch assembly. The inverter is electrically connected to an inductor 610, which is capable of providing power to a device 612, via a corresponding coil 614. As is known, power can be provided from inductor 610 to coil 614 without use of a physical connection. Inverter 608 also is electrically connected to a charger 616, which is electrically connected to switch assembly 606.

In operation, the switch assembly directs the flow of electrical power from a selected one of the batteries, while permitting charging of the other. Power from the selected battery is provided via the switch assembly to the inverter, which directs a portion of its output to the inductor, while directing the remaining portion to the charger.

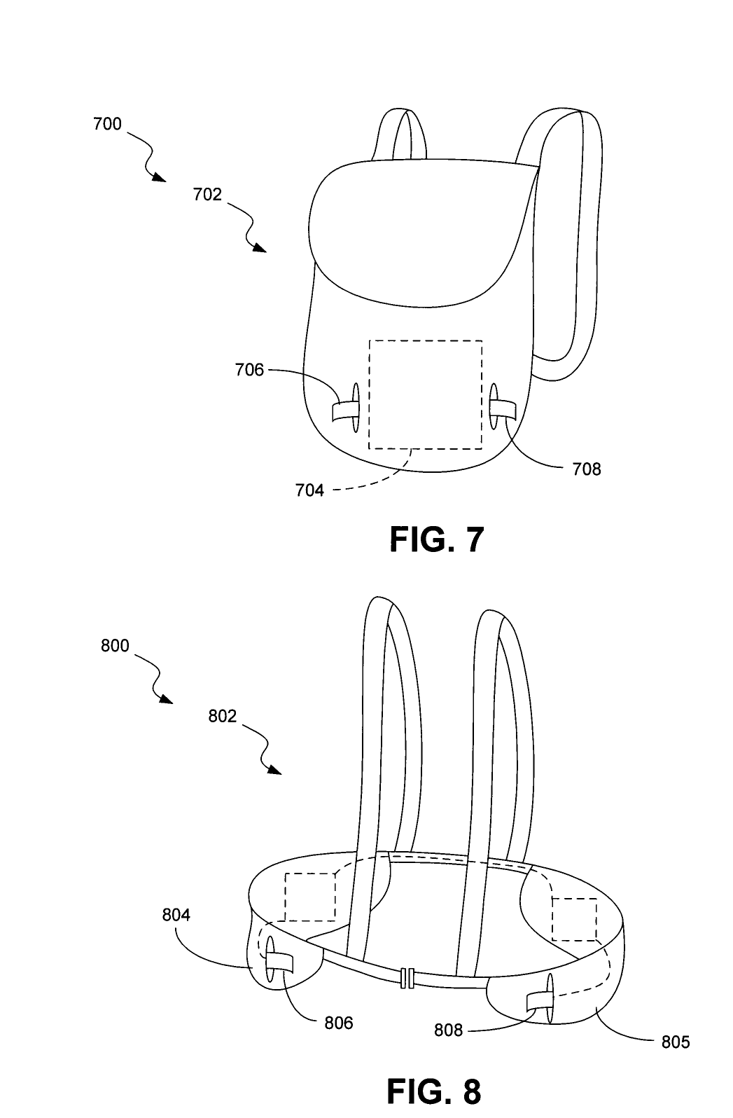

In various embodiments, at least some of the system components can be carried by a pack, such as a wearable pack. By way of example, various back packs and hip packs can be used. FIGS. 7 and 8 depict non-limiting examples of embodiments that include packs.

As shown in FIG. 7, system 700 incorporates a pack 702 configured as a backpack. The pack is sized and shaped to accommodate transport of various system components represented by box 704. Note that the pack includes apertures for permitting pass-through of an outlet 706, which can provide electrical power from a battery of the system to a device, and an adapter 708, which can be used to receive external power for charging the batteries.

In the embodiment of FIG. 8, system 800 incorporates a pack 802 that is configured as a hip-pack. The pack is sized and shaped to accommodate transport of various system components; however, the components are dispersed among the pouches and electrically interconnected such as depicted by the dashed lines. Specifically, at least some of the components (represented by the boxes) are located in each of the pouches 804, 805, with an electrical wire spanning between the pouches. Note that the pack includes apertures for permitting pass-through of an outlet 806, which can provide electrical power from a battery of the system to a device, and an adapter 808, which can be used to receive external power for charging the batteries. Clearly, various other configurations of packs can be used for facilitating portability of the system.

It should be emphasized that the above-described embodiments are merely possible examples of implementations set forth for a clear understanding of the principles of this disclosure. Many variations and modifications may be made to the above-described embodiments without departing substantially from the spirit and principles of the disclosure. By way of example, depending upon the configuration, either or both of AC and DC power can be provided by a system. Additionally, in some embodiments, more than two batteries and/or battery packs (each of which can contain multiple batteries) can be used in a system. In some of these embodiments, a parallel configuration can be used for electrically interconnecting the batteries/battery packs. All such modifications and variations are intended to be included herein within the scope of this disclosure and protected by the accompanying claims.

1. A system comprising:
two rechargeable batteries;
a DC-to-AC inverter; and
a self-recharging system operative to alternately recharge a first of the batteries using charge provided from a second of the batteries, and recharge the second of the batteries using charge provided from the first of the batteries;
wherein the DC-to-AC inverter is operative to direct charge from the first of the batteries to a load during recharge of the second of the batteries, and to direct charge from the second of the batteries to the load during recharge of the first of the batteries.

2. The system of claim 1, wherein:
the inverter receives electrical power from the switch assembly along a first path; and
the system further comprises a charger electrically connected between the inverter and the switch assembly along a second path.

3. The system of claim 2, wherein:
the load is an inductor;
the system further comprises an electrically powered device having a coil; and
the inductor is operative to power the device via the coil.

4. The system of claim 2, further comprising an adapter electrically connected to the charger, the adapter being operative to receive external electrical power for charging the batteries.

5. The system of claim 2, further comprising a photovoltaic cell electrically connected to the switch assembly and operative to provide electrical power for charging the batteries.

6. The system of claim 5, further comprising a light emitting diode operative to emit light onto the photovoltaic cell for recharging the batteries.

7. The system of claim 6, further comprising a power regulator operative to receive power from the inverter and to provide power to the light emitting diode.

8. The system of claim 2, further comprising a motor operative to receive power from the inverter.

9. The system of claim 8, further comprising a generator operative to rotate responsive to the motor and to generate electrical power, the electrical power being provided to the switch assembly for recharging the batteries.

10. The system of claim 2, further comprising a pack operative to house the rechargeable batteries, the inverter and the self-recharging system.

11. The system of claim 10, wherein the pack is a backpack.

12. The system of claim 10, wherein the pack is a hip-pack.

13. The system of claim 12, wherein the hip-pack has removable shoulder straps.

14. The system of claim 2, wherein the self-recharging system comprises a switch assembly operative to direct power for recharging alternately between the first and second of the batteries.

15. A system configured as a cordless power tool comprising:
two rechargeable batteries; and
a motor;
wherein the tool is operative to recharge itself to the extent that a battery can be recharged using kinetic energy from rotation of the motor to generate energy needed to recharge the batteries.

16. The tool of claim 15, wherein the tool is operative to alternately recharge a first of the batteries and a second of the batteries.

17. The tool of claim 15, wherein the tool is a drill.
